(19) United States
(12) Patent Application Publication
(10) Pub. No.: US 2011/0051549 A1
(43) Pub. Date: Mar. 3, 2011

(54) Nucleation Ring for a Central Insert

(76) Inventors: Kristian Debus, Petaluma, CA (US); Thomas Gielda, Saint Joseph, MI (US); Serguei Charamko, Novato, CA (US); Balaji Maniam, Novato, CA (US)

(21) Appl. No.: 12/843,834

(22) Filed: Jul. 26, 2010

Related U.S. Application Data
(60) Provisional application No. 61/228,567, filed on Jul. 25, 2009.

(51) Int. Cl. B01F 13/00

(52) U.S. Cl. 366/342

(57) ABSTRACT

A central insert causes maximum fluid velocity to shift away from an external tube wall reducing friction losses at the tube wall. Centrifugal forces pull fluid away from a central insert wall minimizing friction at the insert wall. The insert may be used in the context of nozzles, flow tubes, vortex tubes, and other fluid pathways. In a nozzle, grooves may be added to the nozzle wall. By introducing these grooves at the exit or end of a nozzle, nucleation may be improved and cavitation may be triggered prior to a fluid entering an expansion tube. The nucleation ring may also be placed at the beginning of a nozzle such that cavitation starts within the nozzle.

### CROSS-REFERENCE TO RELATED APPLICATIONS

The present application claims the priority benefit of U.S. provisional application 61/228,567 filed Jul. 25, 2009, the disclosure of which is incorporated herein by reference.

The present application is related to U.S. provisional patent application No. 61/228,563 filed Jul. 25, 2009 and entitled “Insert for a Vortex Tube” and U.S. provisional patent application No. 61/165,911 filed Apr. 2, 2009 and entitled “Vortex Tube.” The disclosure of each of the aforementioned applications is incorporated herein by reference.

### DESCRIPTION OF THE RELATED ART

The flow pattern of a conventional vortex tube is similar to solid body rotation with zero velocity at the center of rotation and maximum velocity near the tube walls. As fluid inside the tube is expanded under centrifugal force, friction losses become increasingly high. Maximum velocity fluid is pushed onto the tube wall causing large velocity gradients and high shear stresses in the fluid. There is a need for elimination of such gradients and stresses.

### BRIEF DESCRIPTION OF THE DRAWINGS

FIG. 1A illustrates a nozzle with a nucleation ring including grooves.

FIG. 1B is a close up of the nozzle and nucleation ring of FIG. 1A.

FIG. 2 illustrates a conical insert with a spiral vane.

FIG. 3A illustrates a conical insert with a spiral vane.

FIG. 3B illustrates an insert with a cylindrical centerpiece.

FIG. 4A illustrates a CFD model without an insert.

FIG. 4B illustrates a CFD model with an insert.

### DETAILED DESCRIPTION

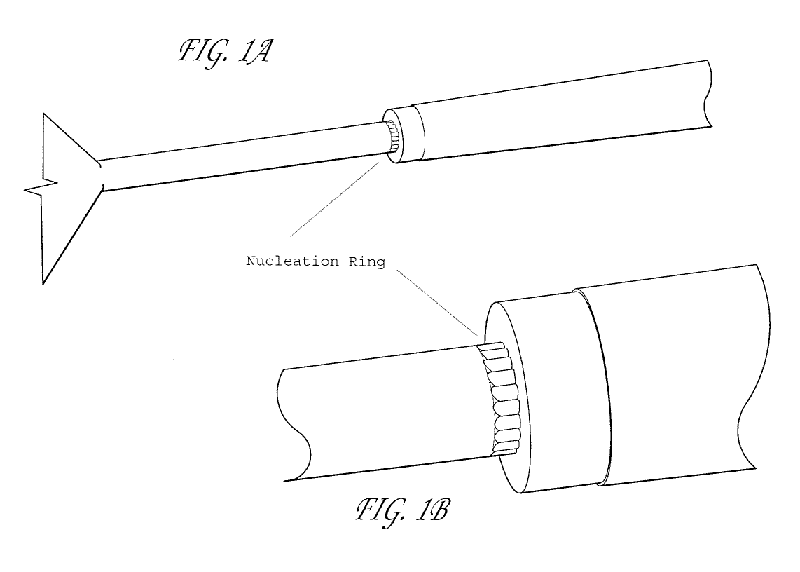

In a nozzle, grooves may be added to the nozzle wall like those illustrated in FIGS. 1A and 1B. By introducing these grooves at the exit or end of a nozzle, nucleation may be improved and cavitation may be triggered prior to a fluid entering an expansion tube. In an alternative embodiment (not shown), the nucleation ring may be placed at the beginning of a nozzle such that cavitation starts within the nozzle.

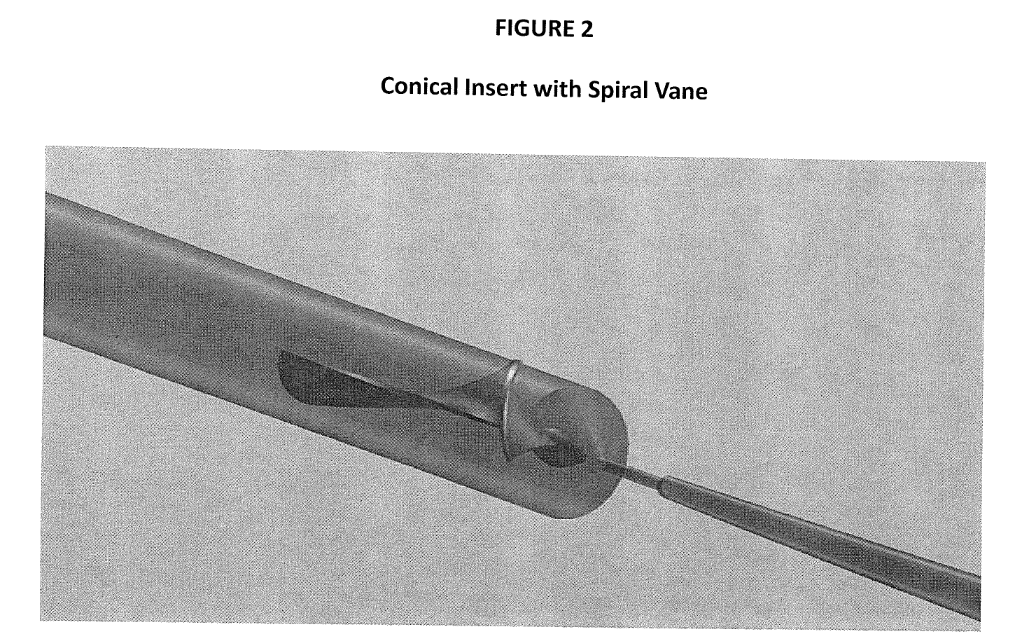

FIG. 2 illustrates a conical insert with a spiral vane. A conical insert with a logarithmic spiral vane will add a rotational component to fluid flow creating a ‘tornado-like’ velocity profile across the pipe cross section. The conical centerpiece may be implemented in the context of the disclosure of U.S. provisional patent application No. 61/228,563 filed Jul. 25, 2009 and entitled “Insert for a Vortex Tube” and U.S. provisional patent application No. 61/165,911 filed Apr. 2, 2009 and entitled “Vortex Tube.” The conical insert stabilizes flow and reduces pressure in the core of the cavitation nozzle. As a result, cavitation is triggered within the nozzle rather than at the sharp edges of a nozzle exit.

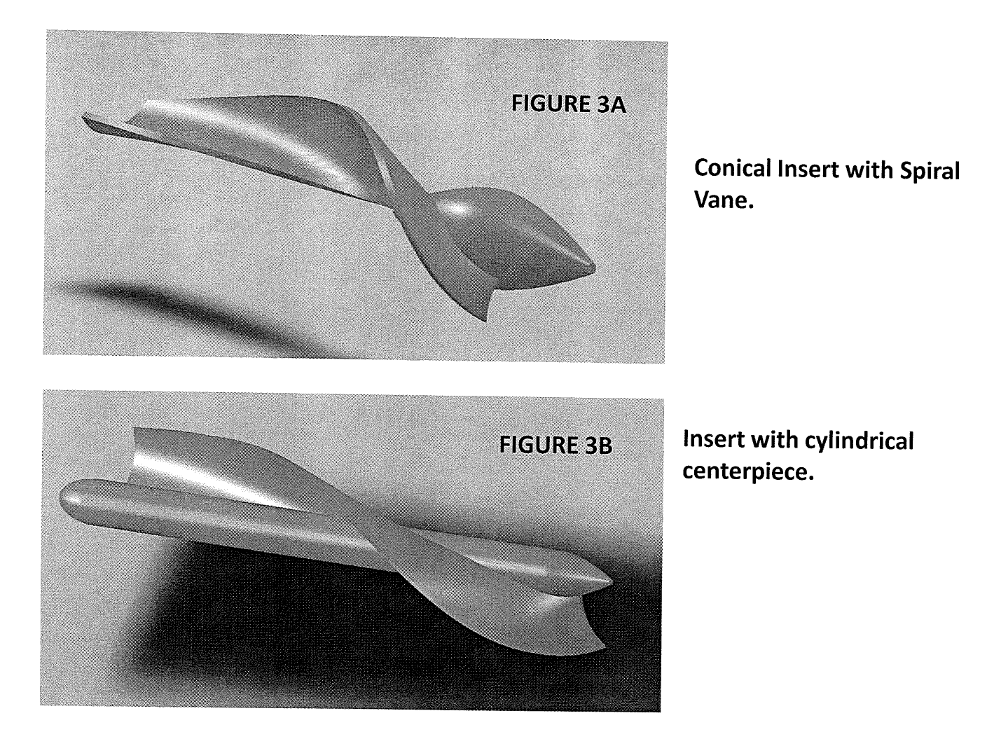

FIGS. 3A and 3B illustrate a conical insert with a spiral vane and an insert with a cylindrical centerpiece, respectively, which may be used in the context of the present invention.

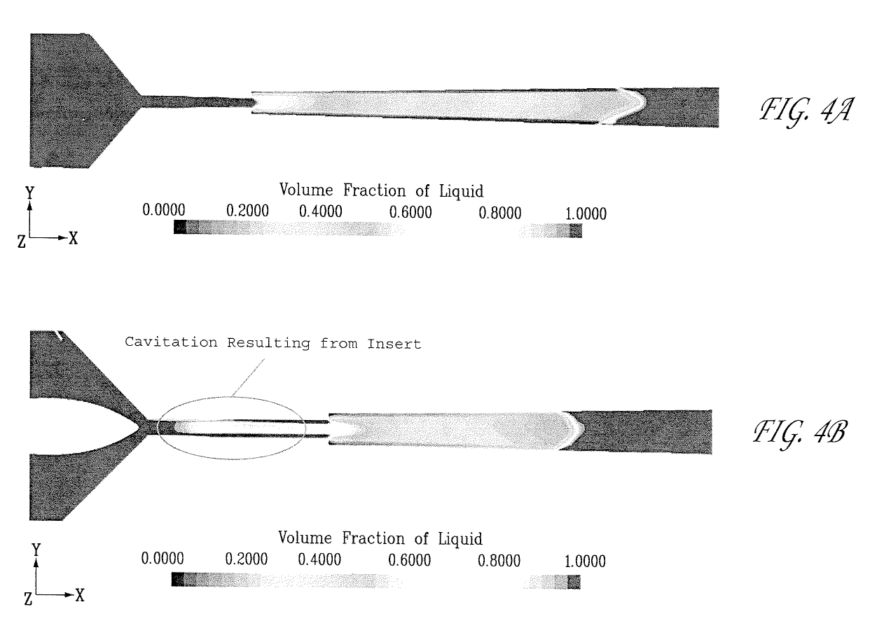

FIGS. 4A and 4B illustrate a CFD model without and with an insert, respectively. The CFD results of FIGS. 4A and 4B indicate the start of cavitation in the nozzle. Cavitation onset is wanted at the location of highest velocity to reach sonic speed of the mixture.

In some embodiments, grooves associated with the nucleation ring or the nucleation ring itself may be introduced to the walls of a flow path within the fluid pathway (e.g., within a manifold). The ring may be introduced as a washer.

What is claimed is:

1. A vortex tube assembly including an insert for causing fluid velocity to shift away from a wall of the vortex tube and a nucleation ring including grooves to trigger cavitation prior to a fluid entering an expansion tube.
